(19) United States
(12) Patent Application Publication
(10) Pub. No.: US 2010/0321246 A1
(43) Pub. Date: Dec. 23, 2010

(54) METHOD FOR DETECTING MOTION

(75) Inventors: Volker Troesken, Witten (DE); Laszlo Hasenau, Bochum (DE)

Correspondence Address: COLLARD & ROE, P.C., 1077 NORTHERN BOULEVARD, ROSLYN, NY, 11576, US

(73) Assignee: amedo smart tracking solutions GmbH, Bochum (DE)

(21) Appl. No.: 12/735,160

(22) PCT Filed: Dec. 22, 2008
(86) PCT No.: PCT/EP2008/011048

§ 371 Date: Jul. 28, 2010

(30) Foreign Application Priority Data
Dec. 21, 2007 (DE) 10 2007 062 843.0

(51) Int. Cl. G01S 3/02

(52) U.S. Cl. 342/463

(57) ABSTRACT

The invention relates to a method for detecting motion (“Motion Capture”), wherein markers (2) are put onto an object (1), the physical positions of the markers are detected and digitized, with the motion of the object (1) being recorded by means of a computer (3) using the chronologically variable digital position data. It is an object of the invention to improve a method of this kind. To this end, the invention proposes that the markers (2) comprise a respective transponder which is activated by electromagnetic radiation (5), specifically such that the transponder emits a location signal as electromagnetic radiation (6), the signal being used to detect the position of the respective marker (2).

The invention relates to a method for motion capture, whereby one or more markers are affixed to an object at predetermined locations, their spatial positions are detected and digitalized, whereby the motion of the object is recorded using the digital position data that change over time.

Motion capture (English: “motion capture”) is understood to mean methods that make it possible to record movements of objects, for example also movements of human beings, and to digitalize the recorded data, so that the digital motion data can be analyzed and stored by means of a computer, for example. Frequently, the recorded digital motion data are used to transfer them to computer-generated models of the object, in each instance. Such techniques are usual nowadays in the production of movies and computer games. The digitally recorded motion data are used, for example, to calculate three-dimensional animated graphics with computer support. Complex motion sequences can be analyzed by means of motion capture, in order to generate animated computer graphics with comparatively little effort. The most varied kinds of movements can be recorded by means of motion capture, namely rotations, translations, as well as deformations of the objects being examined. Capture of movements of objects that move in themselves, which have multiple joints, for example, such as in human beings, which joints can perform movements independent of one another, is possible. The general category of motion capture also includes the so-called “performance capture” technique. In this technique, not only the body movements but also the facial expressions, i.e. the physical mimicry of persons, are recorded and analyzed and processed further by the computer.

In known methods for motion capture, one or more markers are affixed to the object, in each instance, and their spatial positions are determined and digitalized. Such a method is described, for example, in US 2006/0192854 A1. In the previously known method, light-reflecting markers are used. Multiple specially equipped cameras record the movements of the object from different directions. The markers are identified in the recorded video image data, using software, and the spatial positions of the markers are determined from the various positions of the cameras. The motion of the object is finally recorded using the changes over time of the digital position markers, with computer support.

It is disadvantageous that the previously known method is very complicated. For motion capture, it is necessary to record and evaluate video data that are recorded by means of multiple cameras. It is furthermore disadvantageous that while the known method makes it possible to identify the markers in the video data automatically, it is not easily possible in this connection to identify the individual markers, i.e. it cannot be automatically recognized which marker on the object is affixed at which location, in each instance. This allocation must take place “by hand,” essentially, in order to assign the position data of the markers to the corresponding placement locations on the object. This allocation is a prerequisite for a reasonable analysis of the recorded movements, for example when transferring the motion data to a three-dimensional, computer-generated model of the object.

Proceeding from this, it is the task of the invention to make available an improved method for motion capture. In particular, a method is supposed to be created that makes motion capture possible with little effort.

This task is accomplished by the invention, proceeding from a method of the type indicated initially, in that the marker or markers comprise a transponder, in each instance, that is activated by electromagnetic radiation, specifically in such a manner that the transponder emits a localization signal as electromagnetic radiation, on the basis of which the position of the marker, in each instance, is detected.

The basic idea of the invention is the use of a transponder of a known type, as a marker for position determination and motion capture.

An RFID tag is particularly well suited as a marker for motion capture. It is known that RFID is a technology for contact-free identification and localization. An RFID system consists of a transponder and a reader for reading the transponder identification. An RFID transponder (also called an RFID tag) usually comprises an antenna as well as an integrated electronic circuit having an analog part and a digital part. The analog part (transceiver) serves for reception and transmission of electromagnetic radiation. The digital circuit has a data memory in which identification data of the transponder can be stored. In the case of more complex RFID transponders, the digital part of the circuit has a von Neumann architecture. The high-frequency electromagnetic field generated by the reader is received by way of the antenna of the RFID transponder. An induction current forms in the antenna as soon as it is situated in the electromagnetic field of the reader, thereby activating the transponder. The transponder activated in this manner receives commands from the reader by way of the electromagnetic field. The transponder generates a response signal that contains the data queried by the reader. According to the invention, the response signal is the localization signal, on the basis of which the spatial position of the marker is detected.

As compared with conventional methods for motion capture, the method according to the invention has the advantage that it is possible to completely eliminate recording video images with multiple cameras. No recording and processing of video image data is required for motion capture. All that is required to carry out the method according to the invention is a reception unit (reader) for reception of the localization signal.

Another advantage is that each individual marker can be individually identified from among a plurality of markers affixed to the object. Thus, allocation of the detected spatial position of each marker to the related placement location on the object can be carried out automatically. This significantly facilitates automatic processing of the recorded digital position data as compared with conventional methods.

RFID tags are particularly well suited as markers according to the invention, because they have a very small construction size. Miniaturized RFID transponders are available that are as small as a grain of dust. For example, RFID transponders having a size of only 0.05×0.05 mm are known. Such transponders work at very high frequencies, in the range of one gigahertz and above. Such miniaturized RFID transponders can easily be affixed on any desired object whose motion is to be captured. In order to capture the motion of persons, for example, it is possible to integrate a plurality of markers in textiles that are worn by the person. It is also possible to affix RFID tags invisibly, under the skin surface, for position and motion capture. Miniaturized RFID tags are also very well suited for the performance capture technique described above. The markers can be affixed in the region of a person's face, in order to capture the person's facial expressions. When using larger RFID tags, these can be releasably affixed to the object by means of glued, adhesive, suction-cup connections or the like. The most varied application fields of the invention are possible, among other things also in the sector of medical technology. The method according to the invention can be used in the sector of interventional radiology, in order to follow the movements of a medical instrument (for example a catheter, a biopsy needle, an endoscope, etc.) in the examination volume of a diagnostic imaging device, and, if necessary, to visualize it together with diagnostic image data. Furthermore, according to the invention, the markers can be tissue markers for marking lesions and diseased tissue in the human body. Finally, industrial use of the method according to the invention, for example in the sector of logistics or the sector of quality assurance, is also possible, in order to detect and follow up the positions of specific objects (goods, machines, tools, etc.), or in order to monitor specific motion sequences of machines or tools while work is being performed.

It is practical if passive transponders are used as markers for the invention. The power supply of the circuits of the transponders is provided by means of the induction current generated in the antenna when electromagnetic radiation is received. The small construction size of passive transponders is advantageous, since these make do without their own active energy supply, for example in the form of a battery. The energy that the transponders require to emit the localization signals is made available by the electromagnetic radiation by means of which activation of the transponders takes place.

A system for position and motion capture according to the invention comprises a plurality of reception units situated at different locations in space, for reception of a localization signal emitted by a marker of an object, and an evaluation unit connected with the reception units, for determining the position of the marker from the received localization signal. The marker comprises a transponder or some other kind of radio transmitter as a radiation source that emits the localization signal as electromagnetic radiation. In the simplest case, the reception units are antennas that receive the localization signal from different positions. A transmission unit serves for emitting electromagnetic radiation for activation of the transponders. The transmission unit, the reception units, and the evaluation unit together form a reader, as it is fundamentally usual for reading RFID tags, whereby the evaluation unit is expanded to include functions for determining the positions of the markers. A conclusion concerning the distance of the transponders from the reception unit can be drawn from the field intensity of the localization signal at the location of the reception unit, in each instance. If the distances of the transponders from the various reception units that are situated at defined positions in space are known, in turn, the precise position of each individual transponder and thus of the marking on the object can be calculated from this, by means of the evaluation unit.

In some cases, it is problematical, in practice, that the field intensity of the localization signals can be subject to variations, for example due to attenuation of the signals by the object itself, or due to signal reflections from the surroundings. For this reason, a position determination on the basis of the field intensity, i.e. on the basis of the amplitude of the electromagnetic radiation of the localization signals emitted by the transponders of the markers, is not always possible with sufficient accuracy, under some circumstances. To solve this problem, it can be provided that the determination of the positions of the markers takes place (additionally or exclusively) on the basis of the phasing of the electromagnetic radiation of the localization signals at the locations of the reception units. The phasing reacts less sensitively to disruptive ambient influences than the amplitude of the electromagnetic radiation of the localization signals. It is also possible that at first, a rough position determination takes place on the basis of the amplitude, whereby the precision is refined by means of determining the phasing. The position determination on the basis of the phasing also allows greater accuracy than the position determination on the basis of the signal amplitude.

Because of the periodicity of the electromagnetic radiation, the position determination on the basis of the phasing might not be unambiguous, under some circumstances. Either a restricted measurement volume has to be adhered to, within which a clear conclusion concerning the position can be drawn from the phasing, or additional measures have to be taken. Here, a combination of a measurement of the amplitude signals with a measurement of the phasing can provide a remedy. Alternatively or supplementally, it is possible to count the zero-crossings of the localization signal at the locations of the reception units, in each instance, during motion of the object, in order to thereby draw a clear conclusion concerning the correct position.

According to a practical further development of the invention, it can be provided that the electromagnetic radiation of the localization signal emitted by the transponder (or radio transmitter) of the marker, in each instance, is received by means of at least two reception units situated at different locations, in order to determine the position of the marker or markers, whereby the position is determined on the basis of the difference of the phasing of the localization signal received by way of the two reception units. The phase difference can be formed from the localization signal received at the different positions of the reception units. Measuring the phase difference as compared with the absolute phase position is advantageous because the electromagnetic radiation of the localization signal emitted by the transponder (or radio transmitter), in each instance, does not have a defined absolute phasing. The phase-based position determination according to the invention can be further improved in that n≧3 reception units are provided, where n is a natural number and where up to n·(n−1)/2 phase difference values, which are assigned to pairs of reception units, in each instance, are formed from the localization signals received at n locations, by means of a corresponding number of phase detectors, and processed by means of the evaluation unit. By means of a greater number of 5, 10, or more reception units distributed in space, for example, a correspondingly large number of phase difference values can be formed by means of the various possible pairings of the reception units. For example, in the case of 10 antennas distributed in space, 45 pairings can be formed, and accordingly, up to 45 phase difference values can be formed from the received localization signal. This large number of measurement values that are available to the evaluation unit results in great redundancy and thus reliability and accuracy in the position determination. It is advantageous that commercially available and inexpensive phase detectors such as the ones used in PLL modules, for example, can be used to measure the phase differences. Frequently, signal amplifiers for amplifying the received signals are already integrated into such PLL modules.

It is practical if the method of procedure in the position determination on the basis of the phase differences is such that the phase differences generated from the received localization signal are compared with reference phase difference values (for example stored in the memory of the evaluation unit). A simple comparison, if necessary in combination with an interpolation, with the stored reference phase difference values can take place; these are accordingly assigned to corresponding x, y, and z coordinates for position determination. Alternatively, the position determination can take place by means of a neuronal network to which the phase difference values generated from the received localization signal are supplied as input values. The spatial coordinates from which the current position of the marker, in each instance, is derived are then available at the output of the neuronal network. It is practical if a calibration measurement is carried out in advance, in which reference phase difference values are recorded for a plurality of predetermined positions. These can be stored, in simple manner, together with the spatial coordinates of the predetermined positions, in a corresponding data matrix. Likewise, the aforementioned neuronal network can be trained on the basis of the calibration measurement. It is furthermore practical to regularly search for a predetermined reference point with the object or the marker, respectively, independent of the calibration. This can be used to carry out a reconciliation with regard to the coordinate origin at regular intervals. In the position determination, a displacement of the coordinate origin can be very easily compensated, if necessary, by means of a simple vector addition, without a repeated, complete recalibration being necessary.

To achieve the greatest possible accuracy in the determination of the spatial positions of the markers, it can be practical to configure the transponders and the related reception units in such a manner that these work at two or more different frequencies. In this way, a graduated method can be implemented in the position determination, for a successive increase in accuracy. At first, a rough but clear determination of the position can take place by means of generating the localization signals at low frequencies and correspondingly large wavelengths. To increase the accuracy, a switch to a higher frequency is then made, or the frequency of the localization signals is progressively increased further. The demands regarding resolution, in order to achieve a specific spatial resolution, are lower at higher frequencies, in the determination of the phasing. During the successive increase in frequency, the number of zero-crossings can be determined, in order to determine the precise distance between transponder and reception unit. For as precise a position determination as possible, a frequency change in both directions, i.e. from low to high or also from high to low frequencies, is possible. It can be necessary to provide two or more antennas with which the circuits of the transponders are connected, as a function of the frequency ranges that must be covered for the position determination, whereby each of the antennas is assigned to a specific frequency range, in each instance. Likewise, it is possible to use markers that comprise multiple separate transponders, in each instance, which work at different frequencies.

According to the invention, multiple markers are affixed to the object for motion capture, if necessary. The transponders of the markers can be excited either in parallel (so-called bulk reading), or one after the other, in terms of time, to emit localization signals, in order to determine the spatial positions of the markers.

Exemplary embodiments of the invention will be described in greater detail in the following, using the attached drawings. These show:

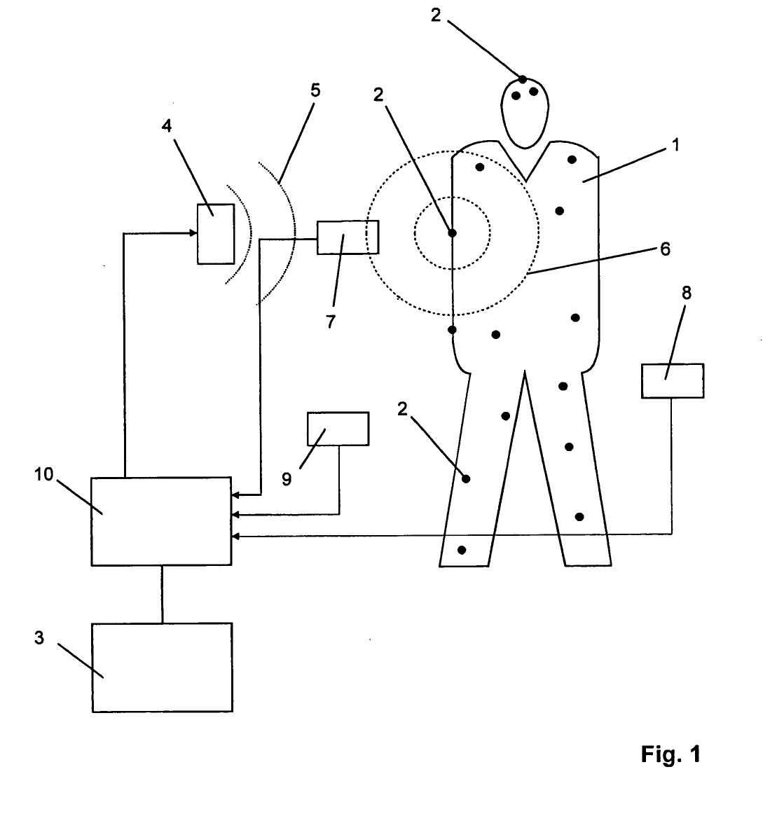

FIG. 1 system for motion capture, according to the invention;

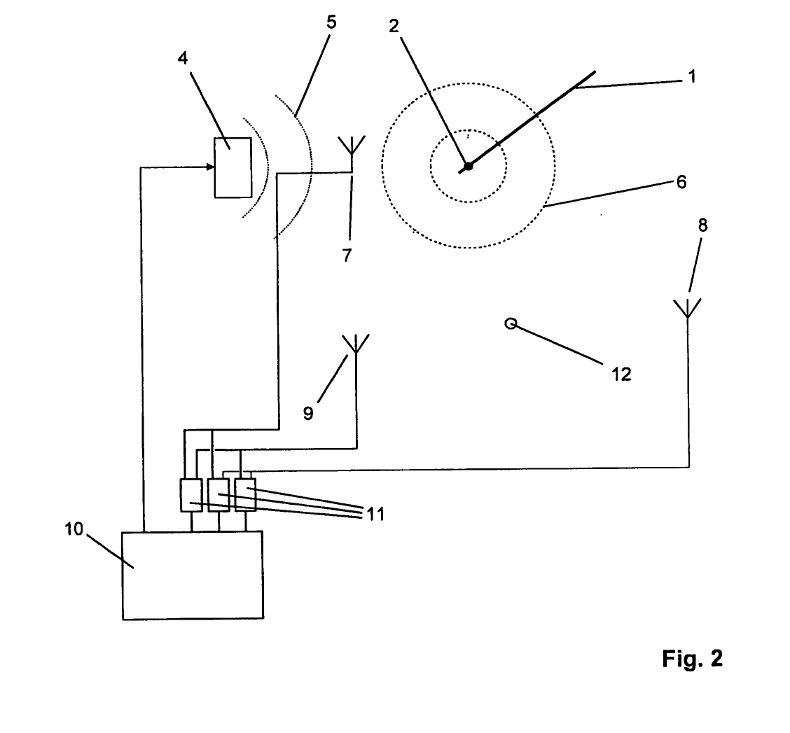

FIG. 2 system according to the invention, for position and/or motion capture, using phase differences.

The system shown in FIG. 1 serves for motion capture. In this connection, what is involved is recording and digitalizing the movements of a person 1. A plurality of markers 2 are disposed on the person 1, distributed over the entire body. For motion capture, the spatial positions of the markers 2 are recorded and digitalized. The motion of the person 1 is registered by a computer 3, on the basis of the digital position data that change over time. The computer 3 can analyze the digital position data of the markers, for example in order to transfer the motion sequences to a three-dimensional model. This modeling can be used in the production of animated computer graphics. In the case of the system shown in the drawing, a transmission unit 4 is provided, which emits electromagnetic radiation 5. According to the invention, the markers 2 comprise a transponder (not shown in any detail in the drawing), in each instance. The radiation 5 is received by the transponders of the markers 2. The transponders are excited by the received radiation 5, so that they in turn emit localization signals as high-frequency electromagnetic radiation 6. The localization signals emitted by the transponders of the markers 2 are received by three reception units 7, 8, and 9 situated at defined positions in space. The reception units 7, 8, and 9 are connected with an evaluation unit 10, which determines the positions of the markers 2 on the basis of the amplitude and on the basis of the phasing of the electromagnetic radiation 6 of the localization signals at the location of the reception units 7, 8, and 9, in each instance. The position data are finally made available to the computer 3 in digital form.

In the case of the exemplary embodiment shown in FIG. 2, the object 1 is a medical instrument, for example a catheter, at the end of which a marker 2 with transponder has been affixed. The three reception units 7, 8, and 9, which are distributed in space, are simple antennas. These are connected with three phase detectors 11 in the three possible pairings. The signals that are present at the output of the phase detectors 11, which are determined by the phase differences of the localization signals 6 received at the locations of the antennas 7, 8, and 9, are passed to the evaluation unit 10 to determine the position of the marker 2. According to the invention, the determination of position takes place on the basis of the differences in the phasing of the localization signal received by way of two reception units 7, 8, and 9, in each instance. The phase differences are formed by means of the phase detectors 11, from the localization signal 6 received at the different positions of the antennas 7, 8, and 9. With n antennas, up to n·(n−1)/2 phase difference values can be formed, which are assigned to antenna pairs, in each instance. The evaluation unit 10 carries out the position determination on the basis of the phase differences, in such a manner that the phase difference values generated from the received localization signal 6 are compared with reference phase difference values stored in memory. From this, the x, y, and z coordinates of the markers 2 are then obtained. Alternatively, the position determination can take place by means of a neuronal network, which the evaluation unit 10 calculates. Before the actual position determination or motion capture, respectively, a calibration measurement is carried out, in which the reference phase difference values are recorded for a plurality of predetermined positions of the marker 2. These are stored in the memory of the evaluation unit 10, together with the spatial coordinates of the predetermined positions. Likewise, the aforementioned neuronal network can be trained on the basis of the calibration measurements. It is furthermore practical to regularly search for a reference point 12, predetermined in space at a fixed location, with the object 1 or the marker 2, respectively. In this way, a reconciliation with regard to the coordinate origin can be carried out at regular intervals.

1. Method for motion capture, whereby at least one marker (2) is affixed to an object (1), its spatial position is detected and digitalized, whereby the motion of the object (1) is recorded using the digital position data that change over time,
wherein
the at least one marker (2) comprises a transponder that is activated by electromagnetic radiation (5), specifically in such a manner that the transponder emits a localization signal as electromagnetic radiation (6), on the basis of which the position of the marker (2) is detected.

2. Method according to claim 1, wherein the transponder has an integrated electronic circuit and an antenna connected with it, for reception and transmission of electromagnetic radiation (5, 6).

3. Method according to claim 2, wherein the transponder is configured as a passive transponder, whereby the power supply of the circuit takes place by means of the induction current generated in the antenna during reception of electromagnetic radiation (5).

4. Method according to claim 1, wherein the transponder is an RFID tag.

5. Method according to claim 4, wherein data regarding the placement location on the object (1) are stored in an electronic data memory of the RFID tag.

6. Method according to claim 1, wherein the determination of the position of the at least one marker (2) takes place on the basis of the amplitude and/or phasing of the electromagnetic radiation (6) of the localization signal emitted by the transponder of the marker (2) at the location of a reception unit (7, 8, 9), by way of which the localization signal is received.

7. Method according to claim 1, wherein in order to detect the position of the at least one marker (2), the electromagnetic radiation (6) of the localization signal emitted by the transponder of the marker (2) is received by means of at least two reception units (7, 8, 9) situated at different locations, whereby the position is determined on the basis of the difference in the phasing of the localization signal received by way of the two reception units (7, 8, 9).

8. Method according to claim 7, wherein the localization signal is received by way of n≧3 reception units (7, 8, 9) situated at different locations, where n is a natural number and where up to n·(n−1)/2 phase difference values, which are assigned to pairs of reception units (7, 8, 9), in each instance, are generated from the localization signals received at n locations, and where the position of at least one marker (2) is determined on the basis of the phase difference values.

9. Method according to claim 7, wherein the position determination takes place in that the phase difference values generated from the received localization signal are compared with reference phase difference values.

10. Method according to claim 7, wherein the position determination takes place by means of a neuronal network to which the phase difference values generated from the received localization signal are passed.

11. Method according to claim 9, wherein a calibration measurement is carried out, in which reference phase difference values are recorded for a plurality of predetermined positions of the at least one marker (2).

12. Method according to claim 10, wherein the neuronal network is trained on the basis of the predetermined position that underlies the calibration measurement and the reference phase difference values recorded.

13. Method according to claim 1, wherein the transponders of the markers (2) are set up for generating the localization signals at two or more different frequencies.

14. Method according to claim 1, wherein the transponders of the markers (2) are excited in parallel or one after the other, in terms of time, to emit localization signals.

15. Method according to claim 1, wherein the markers (2) can be releasably affixed to the object (1) by means of glued, adhesive, suction-cup connections or the like.

16. Method according to claim 1, wherein the markers (2) are integrated into textiles that are worn by a person whose movements are captured.

17. Method according to claim 1, wherein the markers (2) are implanted under the skin surface of a person whose movements are captured.

18. Method according to claim 1, wherein the markers (2) are affixed in the region of the face of a person, in order to capture the person's facial expressions.

19. Method according to claim 1, wherein the object (1) is a medical instrument.

20. Use of a transponder that can be activated by electromagnetic radiation (5), specifically in such a manner that it emits a localization signal as electromagnetic radiation (6), on the basis of which the position of the transponder can be detected, as a marker (2) affixed to an object (1), for detecting the position and/or of motion of the object (1).

21. Use according to claim 20, wherein a plurality of markers (2) are affixed on the object (1) at predetermined locations.

22. Use according to claim 20, wherein the capture of the position of the markers (2) takes place on the basis of the amplitude and/or phasing of the electromagnetic radiation of the localization signals (6) emitted by the transponders, at the location of a reception unit (7, 8, 9) by way of which the localization signals (6) are received.

23. Use according to claim 22, wherein in order to determine the position of the at least one marker (2), the electromagnetic radiation (6) of the localization signal emitted by the transponder of the marker (2) is received by means of at least two reception units (7, 8, 9) situated at different locations, whereby the position is determined on the basis of the difference in the phasing of the localization signal received by way of the at least two reception units (7, 8, 9).

24. Use according to claim 20, wherein the transponder is an RFID tag.

25. Use according to claim 20, wherein the object (1) is a medical instrument.

26. System for position and/or motion capture, having an object (1) on which at least one marker (2) is affixed, a plurality of reception units (7, 8, 9) situated at different locations, for reception of a localization signal emitted by the marker (2), and an evaluation unit (10) connected with the reception units (7, 8, 9), for determining the position of the marker (2) from the received localization signal,
wherein
the at least one marker (2) comprises a radiation source that emits the localization signal as electromagnetic radiation (6).

27. System according to claim 26, wherein the radiation source is a transponder.

28. System according to claim 27, wherein the transponder is activated by means of electromagnetic radiation (5) of a transmission unit (4) and thus excited to emit the localization signal.

29. System according to claim 26, wherein the position of the marker (2) is determined by means of the evaluation unit (10), on the basis of the amplitude and/or phasing of the electromagnetic radiation (6) at the location of at least one of the reception units (7, 8, 9).

30. System according to claim 29, wherein the position is determined by means of the evaluation unit (10) on the basis of the difference in the phasing of the localization signal received by way of two reception units (7, 8, 9), in each instance, for which purpose the reception units (7, 8, 9) are connected with the evaluation unit (10) by way of phase detectors (11).

31. System according to claim 29, wherein n≧3 reception units (7, 8, 9) are provided, where n is a natural number and where up to n·(n−1)/2 phase difference values, which are assigned to pairs of reception units (7, 8, 9), in each instance, are generated from the localization signals received at n locations by means of the phase detectors (11), and processed by means of the evaluation unit (10).
